(19) United States
(12) Patent Application Publication
(10) Pub. No.: US 2016/0290823 A1
(43) Pub. Date: Oct. 6, 2016

(54) METHOD AND SYSTEM FOR PROVIDING ROUTE SEARCH SERVICE

(71) Applicant: NAVER Corporation, Seongnam-si (KR)

(72) Inventors: Hyo Jung Kim, Seongnam-si (KR); Hyun-Soo Kim, Seongnam-si (KR); Soo-Eui Sung, Seongnam-si (KR); HeeJeong Son, Seongnam-si (KR); Rae Na, Seongnam-si (KR)

(21) Appl. No.: 15/087,147

(22) Filed: Mar. 31, 2016

(30) Foreign Application Priority Data
Mar. 31, 2015 (KR) 10-2015-0045264

(51) Int. Cl. G01C 21/36

(52) U.S. Cl. CPC G01C 21/3667; G01C 21/3605

(57) ABSTRACT

Disclosed is a method and system for providing a route search service based on a public transportation map, such as a subway map, a bus map, a rail map, etc. A route search service providing method includes searching for a route from a departure location to a destination using public transportation in response to a route search request, providing a screen displaying the found route on a public transportation map, determining a movement direction of the public transportation map in response to a user input for changing the found route, moving and providing the public transportation map along the movement direction on the screen, changing the departure location or the destination with a point selected on the moved public transportation map, searching again for the route based on the changed departure location or destination, and changing the screen including the moved public transportation map with a screen displaying the route found through a re-search, on the public transportation map.

### CROSS-REFERENCE TO RELATED APPLICATION(S)

This application claims priority under 35 U.S.C. §119 to Korean Patent Application No. 10-2015-0045264 filed on Mar. 31, 2015, in the Korean Intellectual Property Office (KIPO), the entire contents of which are incorporated herein by reference.

### BACKGROUND

1. Field

One or more example embodiments of the present invention relate to technology for providing a route search service based on public transportation information of, such as, a subway, a bus, a train, an airplane, and the like.

2. Description of Related Art

In recent times, with the development in mobile Internet technology and generalization of user terminals, such as smartphones and the like, the use of the mobile Internet at the user terminals has been on the increase.

Owing to the development in the mobile Internet, a user may easily find a way to a desired destination by executing a navigation exclusive application installed in a terminal and by receiving a subway map, and a bus map, and the like. For example, the user may receive a route guide to a desired destination using a personal navigation system (PNS) service. Here, the PNS service refers to a navigation service for guiding a route associated with an operation of a public transportation, such as a subway, a bus, and the like, or a movement through walk.

In the case of using the PNS service, the user may need to change a departure point or a destination depending on a situation of the user, such as in a case in which the user and an acquaintance plan to meet at the same destination from different departure locations and thus, the user needs to inform the acquaintance of a route to the destination. The above situation may frequently occur. However, when the user desires to change the departure location or the destination in a state in which the found route is being provided, the user may need to return to an initial route search screen for inputting the departure location or point and the destination.

### SUMMARY

One or more example embodiments of the present invention provide a route search service providing method and system that may change a departure point or location or a destination on a current screen immediately without a need to return to an initial route search input screen, when a user desires to change a route, such as the departure location, the destination, and the like, in a state in which a route search result is being provided.

One or more example embodiments also provide a route search service providing method and system that may provide a new route found in response to the changed destination or departure location.

According to an aspect, there is provided a route search service providing method implemented in a computer, the method including searching for a route from a departure location to a destination in response to a route search request using public transportation, providing a screen including the found route on a public transportation map, determining a movement direction of the public transportation map in response to a user input for changing the found route, moving and providing the public transportation map along the movement direction on the screen, changing the departure location or the destination with a point selected on the moved public transportation map, searching again for the route based on the changed departure location or destination, and changing the screen displaying the moved public transportation map with a screen showing the route found through re-search, on the public transportation map.

The moving and the providing of the public transportation map may include providing a route that is connected to the public transportation map displayed on the screen before the movement, in response to moving the public transportation map.

The determining of the movement direction of the public transportation map may include determining the movement direction of the public transportation map based on a movement of a user terminal detected using a gyro sensor.

The determining of the movement direction of the public transportation map may include determining the movement direction of the public transportation map based on a direction in which a selected marker pin is moved, in response to selecting the marker pin that indicates the departure or the destination on the screen including the found route.

The providing of the screen displaying the found route may include activating the found route on the public transportation map and processing and thereby providing a remaining route excluding the found route to be dimmed.

The moving and the providing may include reactivating, and thereby providing the route processed to be dimmed in response to a request for changing the found route.

The changing of the departure or the destination may include additionally providing the changed departure or destination on the screen including the moved public transportation map.

The changing of the departure or the destination may include adding the point selected on the moved public transportation map as a via-point, and the searching again for the route may include searching again for the route on the public transportation map based on the departure, the destination, and the via-point.

The public transportation map may include a map of at least one of a subway, a bus, a train, and an airplane.

According to another aspect, there is provided a non-transitory computer-readable recording medium storing instructions to control a computer system to provide a route search result on a public transportation map, wherein the instructions control the computer system to perform searching for a route from a departure location to a destination in response to a route search request using public transportation, providing a screen including the found route on a public transportation map, determining a movement direction of the public transportation map in response to a user input for changing the found route, moving and providing the public transportation map along the movement direction on the screen, changing the departure or the destination with a point selected on the moved public transportation map, searching again for the route based on the changed departure location or destination, and changing the screen including the moved public transportation map with a screen including the route found through re-search, on the public transportation map.

According to still another aspect, there is provided a system for providing a route search service, the system including a route searcher configured to search for a route from a departure location to a destination in response to a route search request using public transportation, an information determiner configured to determine a movement direction of the public transportation map in response to a user input for changing the found route, and a service provider configured to provide a screen including the found route on a public transportation map, and to move and provide the public transportation map along the movement direction on the screen. The route searcher may be further configured to change the departure location or the destination with a point selected on the moved public transportation map, and to search again for the route based on the changed departure location or destination, and the service provider may be further configured to change the screen including the moved public transportation map with a screen including the route found through re-search, on the public transportation map.

The service provider may be further configured to provide a route that is connected to the public transportation map displayed on the screen before the movement, in response to moving the public transportation map.

The information determiner may be further configured to determine the movement direction of the public transportation map based on a movement of a user terminal detected using a gyro sensor.

The information determiner may be further configured to determine the movement direction of the public transportation map based on a direction in which a selected marker pin is moved, in response to selecting the marker pin that indicates the departure location or the destination on the screen including the found route.

The service provider may be further configured to activate the found route on the public transportation map and to process and thereby provide a remaining route excluding the found route to be dimmed.

The service provider may be further configured to reactivate, and thereby provide the route processed to be dimmed in response to a request for changing the found route.

The service provider may be further configured to additionally provide the changed departure or destination on the screen including the moved public transportation map.

The route searcher may be further configured to determine the point selected on the moved public transportation map as a via-point, and to search again for the route based on the departure, the destination, and the via-point.

According to at least one example embodiment, since a public transportation map is moved by detecting an input of a user that is to change a route in a state in which a route search result is being provided, the user may change a destination or a departure location on a route search result screen immediately without a need to return to an initial route search input screen.

Also, according to at least one example embodiment, since an operation of returning to the initial route search input screen is omitted, it is possible to quickly provide a new route found in response to the changed departure location or destination.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an environment between a user terminal and a route search service system according to one exemplary embodiment;

FIG. 2 is a block diagram illustrating a configuration of a route search service system according to one exemplary embodiment;

FIG. 3 is a flowchart illustrating a method of providing a route search service according to one exemplary embodiment;

FIG. 4 illustrates an example of changing a route on a screen for providing a route search result according to an exemplary embodiment;

FIG. 5 illustrates an example of selecting a point desired to change with on a subway map moved in response to a movement of a user terminal according to one exemplary embodiment;

FIG. 6 illustrates an example of moving a subway map on a screen according to an exemplary embodiment;

FIG. 7 illustrates an example of searching for a route based on a changed station according to one exemplary embodiment; and

FIG. 8 illustrates an example of changing a route by dragging and dropping a marker pin according to one exemplary embodiment.

It should be noted that these figures are intended to illustrate the general characteristics of methods and/or structure utilized in certain exemplary embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION

One or more exemplary embodiments of the present invention will be described in detail with reference to the accompanying drawings. Exemplary embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Exemplary embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more exemplary embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more exemplary embodiments, computer processing devices may be described as including various functional units that perform various operations and/or functions to increase the clarity of the description. However, computer processing devices are not intended to be limited to these functional units. For example, in one or more exemplary embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more exemplary embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the exemplary embodiments, or they may be known devices that are altered and/or modified for the purposes of exemplary embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, at least one exemplary embodiment will be described with reference to the accompanying drawings.

The exemplary embodiments may be applicable to a route search service system based on a public transportation map, such as a subway map, a bus map, a rail map, and the like. For example, the exemplary embodiments may be applicable to a variety of fields, such as a map search service, a route guide service, a route find service, and the like, that provides a transportation map.

The term “public transportation” used herein may inclusively indicate any type of transportation, such as a subway, a bus, a train, etc., that include a fixed schedule, a line, and a connection according thereto. Hereinafter, the description will be made by using a subway as a representative example. Also, the term “long-press” used herein may indicate a user behavior of applying physical pressure on the screen of a user terminal on which a subway map and the like is displayed during a reference period of time or more.

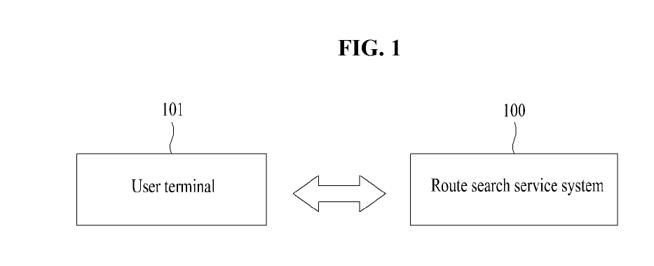

FIG. 1 is a diagram illustrating an environment between a user terminal and a route search service system according to at least one example embodiment. FIG. 1 illustrates a route search service system 100 and a user terminal 101. An indicator with arrowheads may indicate that data may be transmitted and received between the route search service system 100 and the user terminal 101 over a wired/wireless network.

The user terminal 101 may be, for example, a personal computer (PC), a smartphone, a tablet, a laptop, and the like, and may refer to any type of terminal devices capable of connecting to a website/mobile site associated with the route search service system 100 or installing and executing a service exclusive application. Here, the user terminal 101 may perform the overall service operation, such as a service screen configuration, a data input, a data transmission and reception, data storage, and the like, under control of the website/mobile site or the exclusive application.

The route search service system 100 may serve as a service platform that provides a subway map to the user terminal 101. For example, the route search service system 100 may provide the user terminal 101 with a variety of services based on public transportation, such as a subway map service, a route find/route guide service, a map search service, and the like. Further, the route search service system 100 may be configured as an application form on the user terminal 101, and without being limited thereto, may be configured to be included in a service platform that provides a subway map service or a route guide, a map search, and the like based on the subway map service in a client-server environment.

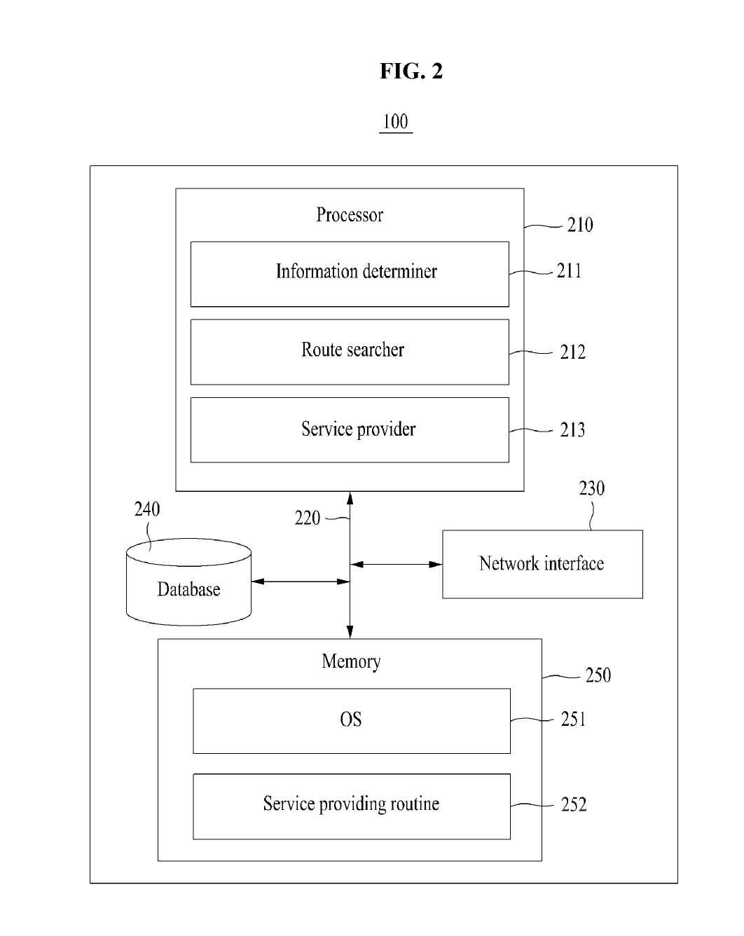

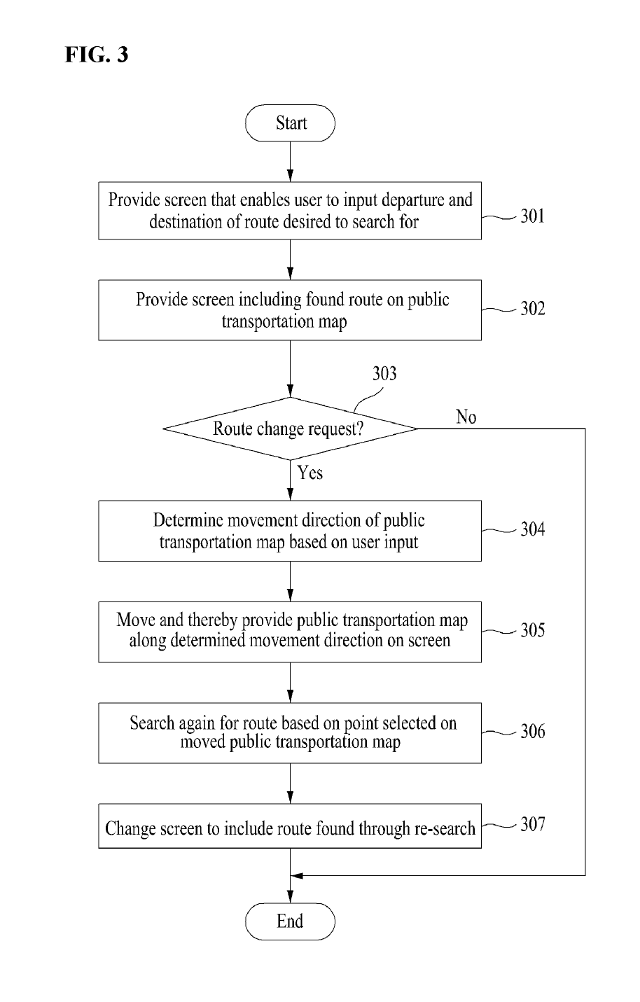

FIG. 2 is a block diagram illustrating a configuration of a route search service system 100 according to one exemplary embodiment, and FIG. 3 is a flowchart illustrating a method of providing a route search service according to an exemplary embodiment.

Referring to FIG. 2, the route search service system 100 includes a processor 210, a bus 220, a network interface 230, a database 240, and a memory 250. The memory 250 includes an operating system (OS) 251 and a service providing routine 252. The processor 210 includes an information determiner 211, a route searcher 212, and a service provider 213. According to other example embodiments, the route search service system 100 may include a greater or less number of constituent elements than the number of constituent elements shown in FIG. 2. However, there is no need to clearly illustrate many constituent elements according to the related art. For example, the route search service system 100 may include other constituent elements, such as a display, a transceiver, etc.

The memory 250 may include a permanent mass storage device, such as random access memory (RAM), read only memory (ROM), a disk drive, etc., as a computer-readable storage medium. Also, program codes (e.g., computer-readable instructions) for the OS 251 and the service providing routine 252 may be stored in the memory 250. Such software constituent elements may be loaded from another computer-readable storage medium separate from the memory 250 using a drive mechanism (not shown). The other computer-readable storage medium may include, for example, a floppy drive, a disc, a tape, a DVD/CD-ROM drive, a memory card, etc. Software constituent elements may be loaded to the memory 250 through the network interface 230 instead of, or in addition to, the computer-readable storage medium.

The bus 220 enables communication and data transmission between the constituent elements of the route search service system 100. The bus 220 may be configured using a high-speed serial bus, a parallel bus, a storage area network (SAN), and/or another appropriate communication technology.

The network interface 230 may be a computer hardware constituent element for connecting the route search service system 100 to the computer network. The network interface 230 may connect the route search service system 100 to the computer network through a wireless and/or wired connection.

The database 240 serves to store and maintain all of information required to provide a transportation information service including a public transportation map. In particular, the database 240 may be constructed such that the route map for each public transportation, such as a subway, a bus, and the like, and information associated with points included in each transit line are matched to stations. For example, in the database 240, a point (a station name, a bus station, and the like) included in each line, transfer information, exit door information, fast transfer information, and the like, are matched and thereby stored in advance. In addition, information required for a route search may be matched to information associated with the point and thereby stored in advance. For example, the travel time between stations, the distance between stations, the transfer time, and the like may be matched to information associated with the point and thereby stored in advance in the database 240.

The database 240 may be included in the route search service system 100, and may be included in the user terminal 101 or both of the route search service system 100 and the user terminal 101 if necessary. Further, the database 240 may be present as an external database configured on a separate system.

The processor 210 is configured to process computer-readable instructions of a computer program by performing basic arithmetic operations, logic operations, and input/output operations of the route search service system 100. The computer-readable instructions may be provided from the memory 250 and/or the network interface 230 to the processor 210 through the bus 220. The processor 210 is also configured to execute program codes for the information determiner 211, the route searcher 212, and the service provider 213. The program codes may be stored in a storage device, such as the memory 250.

The information determiner 211, the route searcher 212, and the service provider 213 may be configured to perform operations 301 through 307 of FIG. 3.

In operation 301, the service provider 213 provides the user terminal 101 with a screen that enables a user to input a departure location and a destination of a route desired to search for. When the user inputs the departure location and the destination on the screen, the route searcher 212 searches for a route from the departure location to the destination using a subway.

For example, the service provider 213 may search for a variety of routes from the departure location to the destination using the subway. The service provider 213 may determine a route corresponding to the fastest travel and a route corresponding to fewest transfers among the routes found.

In operation 302, the service provider 213 provides the user terminal 101 with a screen showing the route found on a public transportation map. Here, the service provider 213 may additionally display a marker pin indicating each of the departure location and the destination on the screen.

For example, the service provider 213 may provide the user terminal 101 with a screen including route 1 corresponding to the fastest travel among routes from station A corresponding to the departure station to station B corresponding to the destination. Here, the service provider 213 may provide the user terminal 101 with a screen on which route 1 is highlighted and remaining lines excluding route 1 are processed to be visibly dimmed on a subway map. In this case, only route 1 may be displayed to be bold and the remaining lines may be displayed to be dimmed on the user terminal 101. In addition, the service provider 213 may provide the user terminal 101 with a screen including route 2 corresponding to the fewest transfer.

In operation 303, the service provider 213 may receive a route change request for changing the found route. Here, the service provider 213 provides the user terminal 101 with a user interface for user interaction, such as a zoom in/out, a touch, a long-press, a drag, and the like, of the subway map to change the found route.

In operation 304, in response to receiving the route change request, the information determiner 211 determines a movement direction of the public transportation map based on a user input.

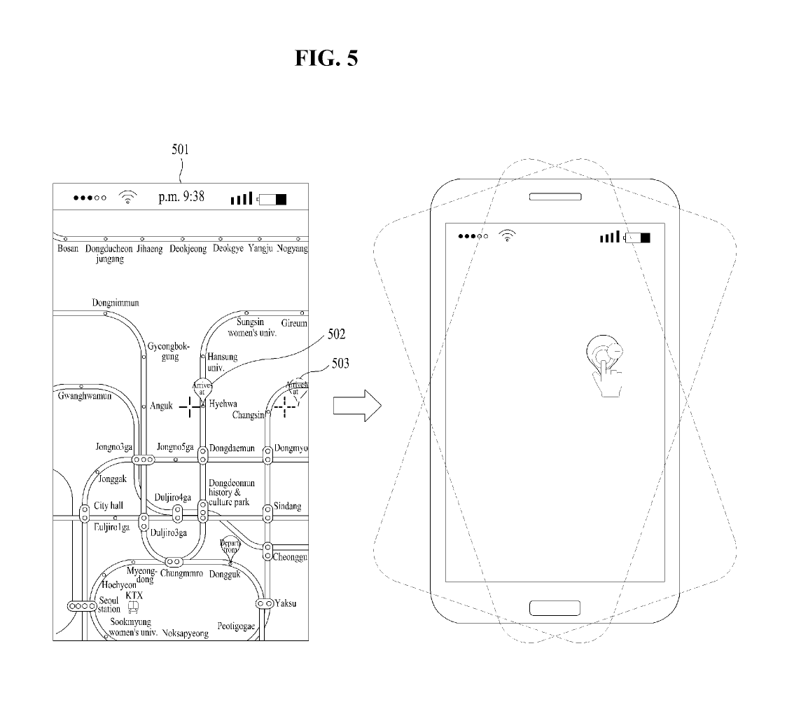

For example, when a user long-presses a marker pin indicating station A during a reference time or more or double clicks the marker pin on a screen on which a fastest travel route from station A to station B is highlighted on a subway map, a route change request may be transmitted. In this case, the information determiner 211 determines the movement direction of the public transportation map based on the direction in which the marker pin of station A moves or the movement of the user terminal 101. An operation of determining the movement direction of the public transportation map will be described with reference to FIGS. 5 through 8.

In operation 305, the service provider 213 moves the public transportation map along the determined movement direction on the screen and thereby provide the moved public transportation map to the user terminal 101.

For example, when the user long-presses and in this state, drags the marker pin of station A to the right of the screen to change the departure station, the service provider 213 provides the subway map that is moved to the left of the screen. As the subway map moves to the left of the screen, the service provider 213 provides the subway map that includes stations before the marker pin is dragged and stations connected to the dragged right direction.

In operation 306, when a point desired to change with is selected on the screen including the moved public transportation map, the route searcher 212 searches again for a route based on the changed point.

For example, when the user drags the marker pin of station A to the right of the screen and then drops the dragged marker pin at station C on the moved subway map, the route searcher 212 searches for routes from station C corresponding to the new departure station to station B corresponding to the original destination. The fastest travel route and the fewest transfer route may be determined among the found routes. When there is no transfer, an operation of determining the fewest transfer route may be omitted.

In operation 307, the service provider 213 changes the screen including the moved public transportation map with a screen including the route found through re-search.

For example, the service provider 213 may provide the user terminal 101 with the fastest travel route including station C as the departure location and station B as the destination on the subway map that is moved to the right of the screen. Here, the service provider 213 may provide the screen on which the fastest travel route is highlighted and remaining lines are processed to be dimmed on the subway map. The service provider 213 may add a marker pin indicating station C as the departure location and a marker pin indicating station B as the destination on the screen.

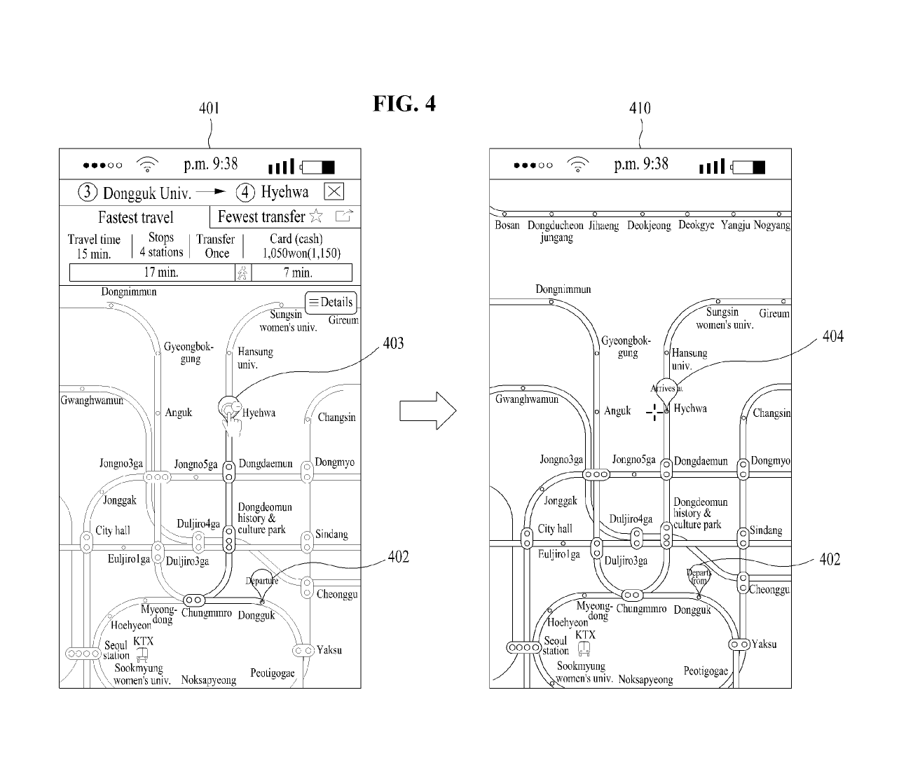

FIG. 4 illustrates an example of changing a route on a screen for providing a route search result according to an exemplary embodiment.

Referring to FIG. 4, in response to a user selecting Dongguk Univ. as a departure station and Hyehwa station as a destination station, the route searcher 212 searches for a route from Dongguk Univ. station to Hyehwa station. The service provider 213 provides the user terminal 101 with a screen 401 including a subway map on which a line that includes stations corresponding to the found route is highlighted and remaining lines are processed to be dimmed. The service provider 213 adds marker pins 402 and 403 indicating the departure station and the destination station, respectively, on the screen 401. For example, the service provider 213 may add the marker pins 402 and 403 around the departure station and the destination station, respectively, on the subway map displayed on the screen 401.

Here, the user may select the marker pin 403 corresponding to the destination station to change the destination station. For example, in response to a long-press or a double click of the marker pin 403, the service provider 213 receives a destination change request. In addition, if a long-press or a double click occurs in a state in which the subway map displayed on the screen 401 is maximally expanded for accurate detection of a long-pressed or double clicked point, a route change request may occur. If the route change request occurs, the service provider 213 reactivates, i.e., undims, the subway lines processed to be dimmed, and thereby provides the subway map on the screen 401.

Here, the service provider 213 adds a marker pin 404 indicating a route changeable state on the screen 401. For example, the service provider 213 may replace the marker pin 403 indicating the destination station with the maker pin 404 indicating the route changeable state. Accordingly, a screen 410 may still include the maker pin 402 indicating the departure station.

FIG. 5 illustrates an example of selecting a point on a subway map to be moved in response to a movement of a user terminal according to one exemplary embodiment. Although FIG. 5 describes a case of long-pressing a marker pin to change a destination station as a representative example, a departure station may be changed by long-pressing a marker pin indicating the departure station. In addition, the user may select or change a via-point (i.e., an intermediate destination between the departure location and the final destination) on a moved subway map using a separate button, an icon, and the like. In addition to the long-press, the user may select a station to change by using a double click and the like.

Referring to FIG. 5, in response to the user long-pressing the marker pin 502 indicating the destination station, the service provider 213 may add a marker pin 503 indicating a route changeable state on a screen 501. If the user tilts and thereby moves the user terminal 101, for example, up, down, left, right, diagonally, and the like, in a state in which the marker pin 503 is added, a gyro sensor (not shown) installed in the user terminal 101 detects the movement of the user terminal 101. In addition to the gyro sensor, a slope sensor, an acceleration sensor, and the like may be used.

For example, the gyro sensor may generate sensing information by detecting the movement of the user terminal 101, and may provide the sensing information to the information determiner 211. The information determiner 211 may determine a movement direction of the user terminal 101 based on the angle of rotation, the size, the azimuth, and the like, of the user terminal 101 included in the sensing information. When the user terminal 101 is determined to have moved to the right, the information determiner 211 may determine the movement direction of the subway map to be opposite to the movement direction of the user terminal 101. For example, the movement direction of the subway map may be determined to be to the left.

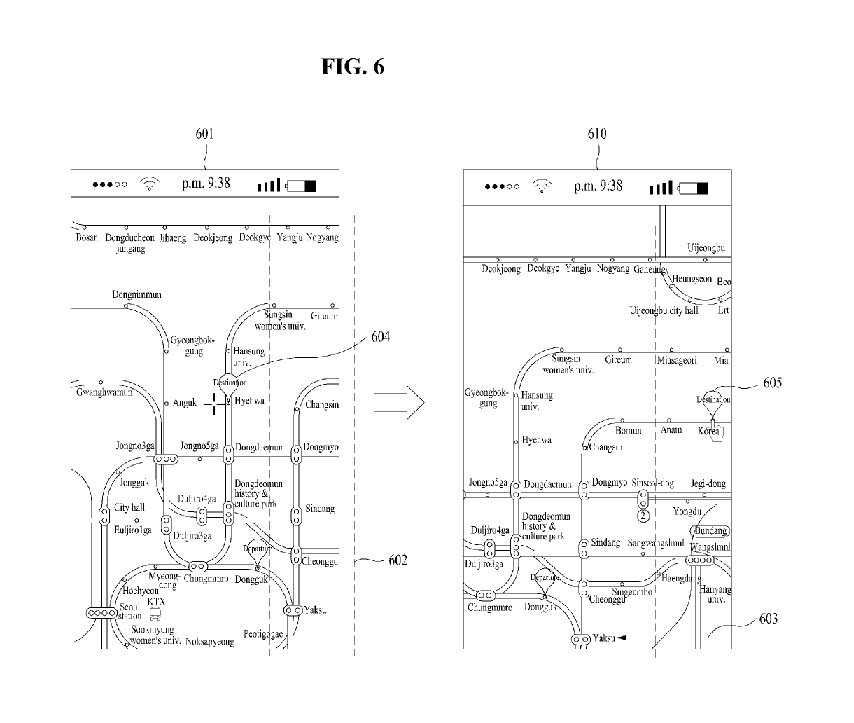

Here, the service provider 213 may move and provide the subway map on the screen 501 so that the subway map may be continuously connected, i.e., continuously shown or displayed, in a direction in which the user terminal 101 is tilted. An operation of moving the subway map to be connected will be described below with reference to FIG. 6. The service provider 213 may move and thereby provide the marker pin 502 in a direction in which the subway map moves. The information determiner 211 may determine whether the marker pin 503 is moved and positioned at the right edge area of the screen 501 as a new marker pin 503. If the marker pin 503 is positioned at the right end of the screen 501 and the user terminal 101 is continuously tilted in the right direction, the service provider 213 may continuously move, and thereby provide, the subway map on the screen 501 so that the subway map is connected in a direction in which the user terminal 101 is tilted. If the user terminal 101 is moved back to a horizontal state, for example, if the user tilts the user terminal 101 having been tilted to the right to the left, to thereby be in a horizontal state, the service provider 213 may provide the screen 501 on which a movement of the subway map is stopped.

FIG. 6 illustrates an example of moving a subway map on a screen according to one exemplary embodiment.

Referring to FIG. 6, if the user terminal 101 is tilted to the right in response to a long-press on a marker pin to change a destination station, the service provider 213 may provide a screen 601 on which the subway map moves to the left to be continuously connected to the right edge of the screen.

For example, as indicated by an arrow 603, the service provider 213 may move the subway map to the left so that Changsin station positioned on a right edge area 602 of the screen 601 may shown to be connected to Bomun station, Anam station on the screen 610, and the like. Here, the information determiner 211 may determine a movement speed of the subway map based on a tilted angle of the user terminal 101. Also, the movement speed may be preset. The service provider 213 may provide a screen that includes the subway map moving based on the determined movement speed and movement direction. For example, the service provider 213 may provide a screen on which the subway map moves quickly according to an increase in a rotation angle of the user terminal 101 and moves slowly according to a decrease in the rotation angle.

Here, when a station to be changed is included in the moved subway map, the user may select the station on a screen 610 that provides the moved subway map. For example, the user may select a destination station to be changed by touching Korea station or by dropping a marker pin 604 at Korea station on the screen 610. In response to the selection of the destination station to be changed, the service provider 213 may add a marker pin 605 indicating the selected destination station on the screen 610.

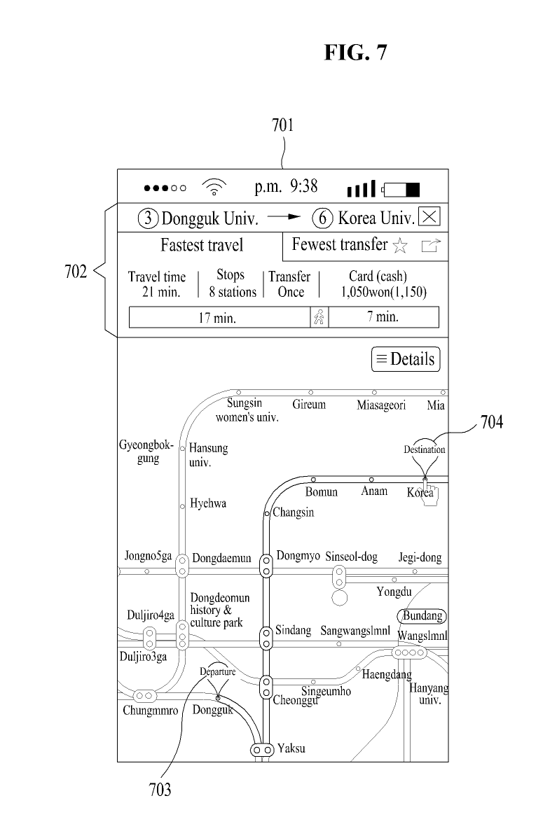

The route searcher 212 may search for a route from Dongguk station corresponding to the departure station to Korea station corresponding to the changed destination station. In this case, the service provider 213 may provide a screen on which the found route is highlighted and remaining lines are processed to be dimmed on the subway map. For example, referring to FIG. 7, the service provider 213 may provide a screen 701 on which the fastest travel route from Dongguk station to Korea station is highlighted and remaining lines are processed to be dimmed on the subway map. Here, the service provider 213 may add information associated with the found route, such as departure station and destination station information, travel time information, transfer information, fare information, stop station information, and the like, on an upper area 702 of the screen 701. The service provider 213 may add marker pins 703 and 704 indicating the departure station and the destination station, respectively, on the screen 701.

When the user is to change the departure station or the destination station, the user may select a point/station to be changed on a current screen on which a search result is displayed, with a simple motion of long-pressing the marker pin 703 or 704, without the need to close the current route search result screen or return to an initial input screen or a previous screen. The service provider 213 may immediately provide the newly found route based on the changed station.

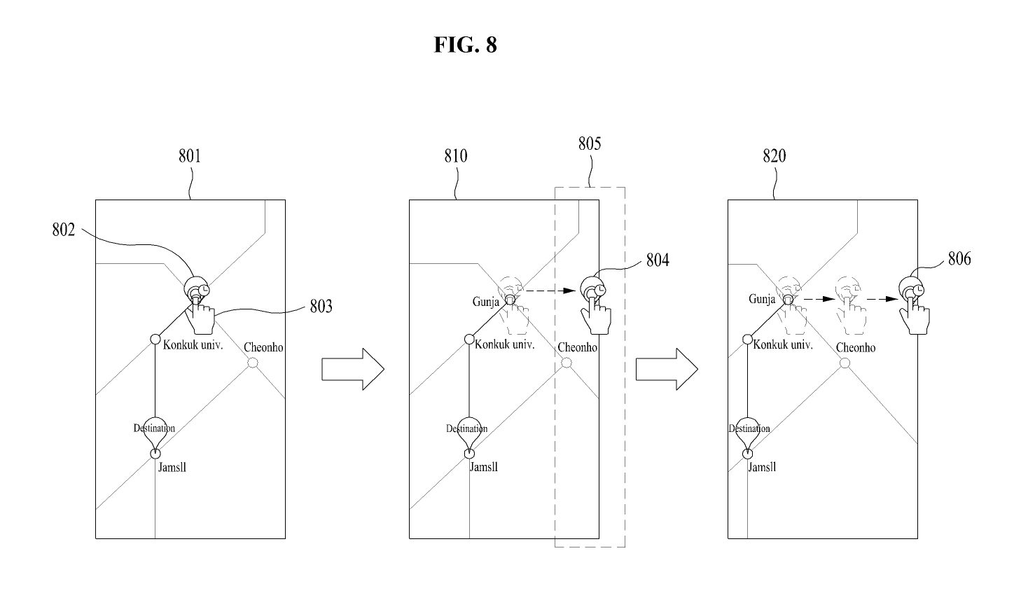

FIG. 8 illustrates an example of changing a route by dragging and dropping a marker pin according to at least one example embodiment. Although FIG. 8 describes a case of long-pressing a marker pin to change a departure station as a representative example, a destination station may be changed by long-pressing a marker pin indicating the destination station. In addition, the user may select or change a via-point on a moved subway map using a separate button, an icon, and the like. In addition to the long-press, the user may select a station to change with using a double click and the like.

Referring FIG. 8, a route found by setting Gunja station as a departure station and Jamsil station as a destination station may be activated on a subway map and thereby provided on a screen 801. In this example, if the user long-presses a marker pin 802 indicating the departure station using a finger 803 in a state in which the subway map is maximally expanded (i.e., a predefined maximum zoom level), a route change request may occur. In a state in which the marker pin 802 is long-pressed, the user may drag the marker pin 802 to the right of the screen 801. If the marker pin 802 is dragged to the right of the screen 801, the information determiner 211 may determine a movement direction of the marker pin 802 based on a pixel direction in which a long-pressed pressure is maintained on the screen 801. The information determiner 211 may determine the movement direction of the subway map to be opposite to the movement direction of the marker pin 802.

For example, the service provider 213 may provide a screen 810 on which the subway map is moved to the right. The service provider 213 may move the subway map to the left to be proportional to a pixel value by which a marker pin 804 is moved. The service provider 213 may add the moved marker pin 804 on the screen 810.

Here, if the marker pin 804 is positioned in an edge area 805 of the screen 810, the service provider 213 may continuously move and thereby provide the subway map to the left. For example, when the user long-presses the marker pin 804 and thereby moves the marker pin 804 to the edge area 805, the information determiner 211 may determine whether the marker pin 804 is positioned on the edge area 805 of the screen 810 based on whether a pressure is applied to pixels present in the edge area 805 of the screen 810.

When the marker pin 804 is positioned in the edge area 805 of the screen 810 in a long-pressed state, the service provider 213 may move and thereby provide the subway map to the left to be connected to lines positioned on the right of the screen 810. Here, the subway map may be moved to the left of the screen 810 until the departure station to be changed is selected. Here, a movement speed of the subway map may be preset, or may be determined to be proportional to a drag speed of a marker pin. The service provider 213 may provide a screen on which the subway map moves to the left at the determined movement speed.

When a departure station to be changed is included on a screen 820 on which the subway map is moved, the user may drop a long-pressed marker pin 806 at the departure station. For example, the user may change the departure station from Gunja station to Myeonmok station by dragging the marker pin 802 of Gunja station included on the screen 801 to the right and by dropping the marker pin 806 at or around Myeonmok station included on the moved screen 820. In this case, the route searcher 212 may search again for a route by setting Myeonmok station as the departure station and by setting Jamsil station as the destination station. The service provider 213 may provide the subway map on which the found route is activated and remaining lines are processed to be dimmed.

According to exemplary embodiments, by providing a screen on which a subway map is moved in a drag direction with tilting a user terminal or long-pressing a marker pin, the user may conveniently select a station to change on the moved subway map regardless of the absence of the station to change with on a screen including an initially found route.

The methods according to exemplary embodiments may be recorded in a non-transitory computer-readable medium in a program instruction form executable through a variety of computer systems.

The program according to exemplary embodiments may be configured in a PC-based program or an application exclusive for a mobile terminal. A traffic information providing application according to exemplary embodiments may be configured in an independently operating program form or an in-app form of a specific application to be operable on the specific application.

The methods according to example embodiments may be performed in such a manner that the traffic information providing application controls a user terminal. The application may be installed in the user terminal through a file provided from a file distribution system. For example, the file distribution system may include a file transmitter (not shown) to transmit the file in response to a request of the user terminal.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A route search service providing method implemented in a computer, the method comprising:
searching for a route from a departure location to a destination using public transportation, in response to a route search request;
providing a screen displaying a route found in the search, on a public transportation map;
determining a movement direction of the public transportation map in response to a user input for changing the found route;
moving and providing the public transportation map along the movement direction on the screen;
changing the departure location or the destination with a point selected on the moved public transportation map;
searching for a new route based on the changed departure location or destination; and
changing the screen displaying the moved public transportation map with a screen displaying the new route found through the search for the new route, on the public transportation map.

2. The method of claim 1, wherein the moving and the providing of the public transportation map comprises providing the found route that is connected to the public transportation map displayed on the screen before the movement of the public transportation map, in response to moving the public transportation map.

3. The method of claim 1, wherein the movement direction of the public transportation map is determined based on a movement of a user terminal detected using a gyro sensor.

4. The method of claim 1, wherein the movement direction of the public transportation map is determined based on a direction in which a selected marker pin is moved, in response to selecting the marker pin that indicates the departure location or the destination on the screen displaying the found route.

5. The method of claim 1, wherein the providing of the screen displaying the found route comprises activating the found route on the public transportation map, and dimming remaining routes excluding the found route.

6. The method of claim 5, wherein the moving and the providing of the public transportation comprises undimming the remaining routes in response to a request for changing the found route.

7. The method of claim 1, wherein the changing of the departure location or the destination comprises additionally providing the changed departure location or destination on the screen displaying the moved public transportation map.

8. The method of claim 1, wherein the changing of the departure location or the destination comprises adding the point selected on the moved public transportation map as a via-point, and
the searching for the new route comprises searching for the new route on the public transportation map based on the departure location, the destination, and the via-point.

9. The method of claim 1, wherein the public transportation map comprises a map of at least one of subway routes, bus routes, train routes, and airplane routes.

10. A non-transitory computer-readable recording medium including instructions to control a computer system to provide a route search result on a public transportation map, wherein the instructions control the computer system to execute the steps comprising:
searching for a route from a departure location to a destination using public transportation, in response to a route search request;
providing a screen displaying a route found in the search, on a public transportation map;
determining a movement direction of the public transportation map in response to a user input for changing the found route;
moving and providing the public transportation map along the movement direction on the screen;
changing the departure location or the destination with a point selected on the moved public transportation map;
searching for a new route based on the changed departure location or destination; and
changing the screen displaying the moved public transportation map with a screen displaying the new route found through search for the new route, on the public transportation map.

11. A system for providing a route search service to a user terminal, the system comprising:
a route searcher configured to search for a route from a departure location to a destination using public transportation, in response to a route search request from the user terminal;
an information determiner configured to determine a movement direction of the public transportation map in response to a user input from the user terminal for changing the found route; and
a service provider configured to provide a screen displaying the found route on the public transportation map on the user terminal, and to move and provide the public transportation map along the movement direction on the screen,
wherein the route searcher is further configured to change the departure location or the destination with a point selected on the moved public transportation map, and to search for a new route based on the changed departure location or destination, and
the service provider is further configured to change the screen displaying the moved public transportation map with a screen displaying the new route found through the search for the new route on the public transportation map.

12. The system of claim 11, wherein the service provider is further configured to provide the found route that is connected to the public transportation map displayed on the screen before the movement of the public transportation map, in response to moving the public transportation map.

13. The system of claim 11, wherein the information determiner is further configured to determine the movement direction of the public transportation map based on a movement of the user terminal detected using a gyro sensor.

14. The system of claim 11, wherein the information determiner is further configured to determine the movement direction of the public transportation map based on a direction in which a selected marker pin is moved, in response to selecting the marker pin that indicates the departure location or the destination on the screen displaying the found route.

15. The system of claim 11, wherein the service provider is further configured to activate the found route on the public transportation map, and dim remaining routes excluding the found route.

16. The system of claim 15, wherein the service provider is further configured to undim the remaining routes in response to a request for changing the found route.

17. The system of claim 11, wherein the service provider is further configured to additionally provide the changed departure location or destination on the screen displaying the moved public transportation map.

18. The system of claim 11, wherein the route searcher is further configured to determine the point selected on the moved public transportation map as a via-point, and to search for the new route based on the departure location, the destination, and the via-point.
